(19) United States
(12) Patent Application Publication
(10) Pub. No.: US 2012/0109819 A1
(43) Pub. Date: May 3, 2012

(54) SYSTEMS AND METHODS FOR PROVIDING CUSTOMIZED INSTALLMENT PAYMENT PLANS

(75) Inventor: Emmanuel Poku Aidoo, Hoboken, NJ (US)

(73) Assignee: Transatlantic Solutions, LLC, Jersey City, NJ (US)

(21) Appl. No.: 12/913,552

(22) Filed: Oct. 27, 2010

(51) Int. Cl. G06Q 40/00; G06Q 10/00

(52) U.S. Cl. 705/40; 705/5

(57) ABSTRACT

Systems and methods for making installment payments are disclosed. The installment payments may be used to purchase flights or travel packages and may be made online. The installment payments may be customizable and provide a consumer with more flexibility than standard payment options.

### FIELD OF THE DISCLOSED SUBJECT MATTER

This is directed to systems and methods for providing customized installment payment plans.

### BACKGROUND OF THE DISCLOSURE

In today's increasingly connected society, people find themselves traveling more than ever, for both business-related and personal trips. Additionally, consumers often book their travel packages, which may also include, for example, flights, hotel accommodations and/or ground transportation, at the last minute for a variety of reasons, including for example, scheduling uncertainties, financial constraints, and unplanned business or personal events.

Consumers often purchase these travel packages online. Online purchases offer consumers convenience and savings, as they can be made from nearly anywhere and allow consumers to easily “shop around” and compare prices between multiple vendors. Online purchases are often also beneficial to vendors, as they allow vendors to reduce overhead costs and reach customers based around the world.

Unfortunately for consumers, however, last-minute purchases are often more expensive than purchases made far in advance of a travel date. Additionally, consumers often have limited payment options, and are frequently forced to pay for most or all of the cost of the flight during the initial booking. For some consumers, the higher prices associated with these last-minute purchases can be prohibitive and, in some cases, can prevent the consumer from making a purchase altogether. This can also hurt vendors, as it may lead to decreased revenues and reduced customer loyalty.

Consequently, more flexibility is needed in payment systems, especially in the field of travel package purchases. This added flexibility will benefit both consumers and vendors

### SUMMARY OF THE DISCLOSURE

Systems and methods are provided for online sales and customized installment payment plans for the purchase of travel packages.

Using “standard” payment plans, a consumer may not be able to afford an expensive travel package, especially when booking the travel package at the last minute, when prices are often highest. Under standard payment plan rules, consumers are often forced to pay for the entire purchase upfront. If consumers want to delay payment using these standard payment plans, they are often forced to pay the entire balance upfront using credit cards, which often have high interest rates and have fixed spending limits. Using flexible installment payment plans can alleviate several of these problems.

In one embodiment, a consumer uses a website to search for a travel package. The consumer can use search fields on the website to specify flight dates, times, cities, and other relevant search parameters. After receiving the search parameters, a processor can aggregate results using a search consolidator database and present them to the consumer. In certain embodiments, the data stored in the search consolidator database can be provided by an outside search consolidator service. The processor can also calculate whether an installment payment plan is available to the consumer. The processor can then calculate one or more payment options and present the payment options along with the search results to the consumer for review and further processing.

The payment options available to the consumer can be calculated based on a number of factors. For example, the consumer may have more payment options available to him the earlier he reserves his flight. In certain embodiments, the payment options may vary based on the base cost of the desired travel package. Depending on what payment options are available to the consumer, deposit fees may be required. If the consumer does not initially qualify for an installment payment plan, in certain embodiments, he may be offered the option of installment payments based on the purchase of additional services or by meeting certain payment conditions. Payment options may also be affected by the consumer's credit rating.

The total purchase price for the consumer may include one or more deposit fees. The deposit fees may be calculated based on a number of factors including, for example, airline and/or hotel refund fees, a search consolidator's administration fees, and any layaway or installment fees.

After the fees and travel options are calculated, they can be presented to the consumer for review. The consumer may have travel and payments options to choose from and can select from them based on his personal preferences and needs. If the consumer is paying using an installment plan, he can make an initial deposit using any suitable payment means (e.g., credit card, debit card, online bank, etc.). In certain embodiments, the consumer then may pay regular installments on a fixed or variable basis and may complete payment before going on his flight or trip. In certain embodiments, the consumer may extend his payment plan or cancel the payment plan and be subject to potential cancellation fees.

### BRIEF DESCRIPTION OF THE DRAWINGS

The above and other aspects and advantages of the disclosed subject matter will be apparent upon consideration of the following detailed description, taken in conjunction with accompanying drawings, in which like reference characters refer to like parts throughout, and in which:

FIG. 1 is a schematic view of an illustrative electronic device that can be used to access and/or run an electronic installment payment system according to some embodiments of the invention;

FIG. 2 is a schematic view of an illustrative electronic installment payment system according to some embodiments of the invention;

FIG. 3 is a schematic view of an illustrative user interface for an electronic installment payment system according to some embodiments of the invention;

FIG. 4 is a flowchart of an illustrative process for calculating payment options according to some embodiments of the invention; and

FIG. 5 is a flowchart of an illustrative process for collecting installment payments according to some embodiments of the invention.

### DETAILED DESCRIPTION

Systems and methods are disclosed for online sales and customized installment payment plans.

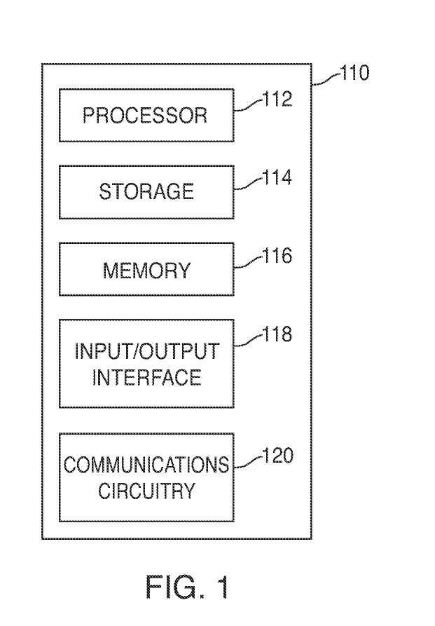

An electronic device used as part of the disclosed systems and methods can perform some or all of the features described above and below and can include any suitable combination of hardware, firmware, and software for implementing an installment payment system. FIG. 1 is a schematic view of an illustrative electronic device 110 that can be used to access and/or run an electronic installment payment system.

Electronic device 110 may include processor 112, storage 114, memory 116, input/output interface 118, and communications circuitry 120. In some embodiments, one or more components of electronic device 110 may be combined or omitted (e.g., combine storage 114 and memory 116). In some embodiments, electronic device 110 may include other components not combined or included in those shown in FIG. 1 (e.g., location circuitry, sensing circuitry detecting the device environment, or a bus connecting the other components of the device), or several instances of the components shown in FIG. 1. For the sake of simplicity, only one of each of the components is shown in FIG. 1.

Processor 112 may include processing circuitry and/or control circuitry operative to control the operations and performance of electronic device 110. For example, processor 112 may be used to run operating system applications, firmware applications, or any other application on electronic device 110. In some embodiments, processor 112 can drive a display and process inputs received from a user interface (e.g., interface 118).

Storage 114 may include, for example, one or more storage mediums. For example, storage 114 may include a hard-drive, solid state drive, flash memory, permanent memory (e.g., ROM), any other suitable type of storage component, or any combination thereof.

Storage 114 may store, for example, application data (e.g., for implementing functions on device 110), firmware, user preference information, authentication information (e.g., libraries of data associated with authorized installment payment system users).

Memory 116 can include cache memory, semi-permanent memory such as RAM, and/or one or more different types of memory used for temporarily storing data. In some embodiments, memory 116 can also be used for storing data used to operate electronic device applications, or any other type of data that may be stored in storage 114. In some embodiments, memory 116 and storage 114 may be combined as a single storage medium.

Input/output interface 118 may provide inputs to input/output circuitry of the electronic device. Input/output interface 118 may include any suitable input interface, such as for example, a button, a mouse, a keyboard, or a touch screen. The input interface can include an analog to digital converter for converting received analog signals corresponding to a voice input to a digital signal that can be processed and analyzed to identify specific words or instructions.

In some embodiments, input/output interface 118 can instead or in addition include one or more interfaces for providing an audio output, visual output, or other types of output. For example, input/output interface 118 can include one or more speakers. Input/output interface 118 can also include display circuitry (e.g., a screen or projection system) for providing a display visible to the user. The display can include a screen (e.g., an LCD screen) incorporated in electronic device 110, a movable display or a projecting system for providing a display of content on a surface remote from electronic device 110 (e.g., a video projector), or any other suitable display. Input/output interface 118 can interface with input/output circuitry (not shown) to provide outputs to a user of device 110.

Communications circuitry 120 can be operative to create or connect to a communications network. In some embodiments, communications circuitry 120 can provide wireless communications using any suitable short-range or long-range communications protocol. For example, communications circuitry 120 can support Wi-Fi (e.g., a 802.11 protocol), Bluetooth (registered trademark), radio frequency systems (e.g., 1200 MHz, 2.4 GHz, and 5.6 GHz communication systems), infrared, protocols used by wireless and cellular telephones and personal email devices, or any other protocol supporting wireless communications. Communications circuitry 120 can also be operative to connect to a wired communications network.

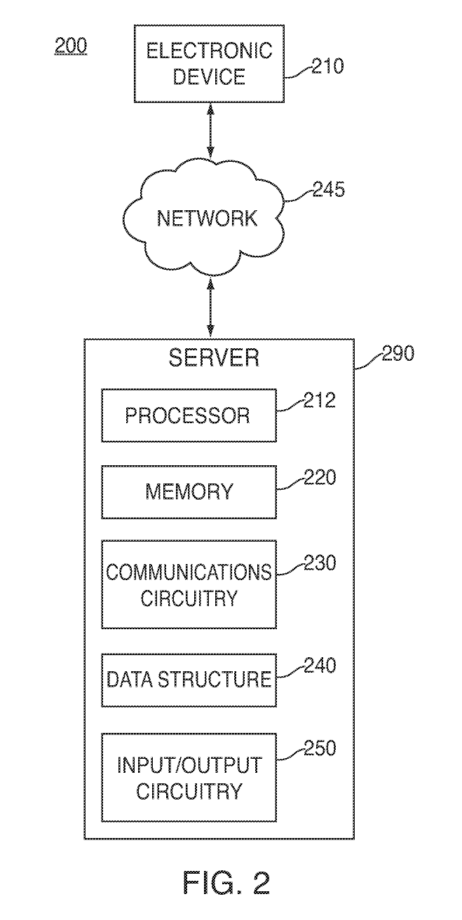

FIG. 2 is a schematic view of an illustrative electronic installment payment system 200.

System 200 may include a device 210, communications network 245, and a server 290. Device 210 may be similar to electronic device 110 of FIG. 1. Server 290 may include a processor 212, memory 220, communications circuitry 230, data structure 240, and input/output circuitry 250. The processor and other system components may be similar to components described in FIG. 1. Further, server 290 may include several instances of certain components. For example, server 290 may include more than one processor, each with its own associated circuitry. In some embodiments, one or more components of device 210 may be combined or omitted. For example, in certain embodiments, data structure 240 may be stored on memory 220. In some embodiments, server 290 may include other components not combined or included in those shown in FIG. 2 or several instances of the components shown in FIG. 2.

In certain embodiments, a user can use device 210 to access a sales website maintained by server 290 where he can purchase a travel package. The website can be used to search for and purchase travel packages. The travel packages may include, for example, flights, travel accommodations and/or lodging, depending on the user's needs. In certain embodiments, a user can use device 210 to access a mobile version of the sales website. The user can use device 210 to enter search parameters related to his flight or trip. For example, the user may perform a search based on departure and/or return dates. The user may also list departure and/or arrival cities for his travel. The user may also search on the website by entering the maximum price he is willing to pay for his travel. If the user's travel package the user includes a hotel room and/or ground transportation, he may also enter his accommodation and ground transportation preferences. Device 210 can then send this data to server 290 for further analysis via communications network 245.

After receiving the user's search parameters, in certain embodiments, processor 212 can access a data structure 240, which can store available travel packages. Data structure 240 may be stored remotely on a distinct server, or may be stored in memory 220. If the data structure is stored remotely, Server 290 may use communications circuitry 230 to access the data structure. Data structure 240 may be generated by a third-party travel consolidator organization, which can consolidate travel package results that meet the user's search criteria from multiple hotel and travel vendors and store the results in a single database for easy access and price comparison.

Processor 212 can then calculate prices and payment options based on the available travel packages. In certain embodiments, Processor 212 can also customize prices and payment options based on user-specific criteria (e.g., credit rating, past purchases, rewards points, etc.). Additionally, the user may have more payment options available to him the earlier he reserves his flight. The payment options may also vary based on the base cost of the desired travel package. Depending on what payment options are available to the user, deposit fees may be required. If the user does not initially qualify for an installment payment plan, in certain embodiments, he may be offered the option of installment payments based on the purchase of additional services or by meeting certain payment conditions.

In certain embodiments, the user may need to qualify for certain payment options, and certain users may qualify for options that are not available to other users. For example, a user with a meeting certain predetermined requirements may qualify for more flexible payment options than users with lower credit ratings. Further, a return user who has used system 200 before may qualify for special sales or deals that other users may not. Such sales or deals may act as an incentive for a user to continue booking travel packages through the installment payment system and may encourage other potential consumers to use system 200. In certain embodiments, system 200 may require the user to login, entering a selected username and password, and allowing the user to establish an account storing previous purchase history, payment history, credit rating information and/or user preferences on a system memory 220 or on a remotely stored memory or data structure 240.

For example, a user may wish to book a flight three months in advance of the travel date from New York to Los Angeles. In certain embodiments, he can access a search website hosted by server 290 and enter his search parameters (e.g., departure/arrival dates, departure/arrival cities, seating preferences, and/or a maximum price he is willing to pay) using electronic device 210 which can communication with server 290 via communications network 245. After server 290 receives the data, processor 212 can then use the parameters or data related to these parameters to search for matching flights stored in data structure 240. If data structure 240 is stored remotely, processor 212 may use communications circuitry 230 to access the data structure, which may include a number of flights provided by various airlines that meet the consumer's search parameters (e.g., flights from New York to Los Angeles on the dates and within the acceptable price ranges specified by the user). If the user is interested in booking a travel package, processor 212 may access a data structure that also includes data about hotel and/or rental car availability and pricing.

After retrieving this information, processor 212 can then calculate payment options and the total costs for the consumer.

In certain embodiments, purchasing a refundable travel package may automatically qualify the user for an installment payment plan. The installment payment plan may require the user to pay for the travel package in full by a certain time before the start date of the travel package and charge the user additional fees and/or cancel the travel package if the balance is not paid off in time. For example, an installment payment plan may require that a user pay for an airlines ticket in full by at least 14 days before the departure time of the flight. If the user is purchasing a non-refundable travel package, he may still be able to pay using an installment plan if he purchases a “layaway option” that can be offered to the user on the search website. Further, in certain embodiments, a user may qualify for an installment payment plan if he purchases travel insurance for his trip.

When the user and his search parameters qualify for an installment payment plan, the processor can also calculate the total number of installments and how much each installment will cost. The number of installments and the amount of each installment for a given installment payment plan can be calculated based on several different factors.

For example, the number of installments may be based in part on how far in advance the user books his travel package. In certain embodiments, a payment can be divided into more installments if the user books his travel package further in advance than it can if the user books a “last-minute” trip. In certain embodiments, the user may have the option of selecting how many installments to divide the payment into.

Additionally, the installment payments can be evenly divided or may be variable in cost and duration between payments, depending on user-preferences and other considerations. For example, if a user prefers to pay a large up-front installment payment, the installments may be configured such that the first one is the most expensive and the balance is divided evenly among the remaining installments. Similarly, installments may be configured such that they become more expensive over time, allowing the user to make a smaller initial payment and to increase his payments at the end of the installment payment cycle. In certain embodiments, installments may be configured to vary throughout the installment payment cycle. They may increase or decrease throughout the course of the cycle based on user preferences. Further more, the time between payments may vary in some embodiments.

Processor 212 can also calculate the total cost of the user's purchase. The total cost can include the cost of the travel package charged by the airline, hotel, and/or ground transportation provider or providers and can also include a number of associated fees. The fees may include any refund or cancellation fees that may be charged by the airline, hotel, or ground transportation provider or providers, administration fees charged by search consolidators that may provide the initial list of available travel packages, and a layaway fee that may be required as a condition of selecting an installment payment plan. In certain embodiments, the cancellation fees may be refundable if, for example, the user does not cancel his transaction. The layaway fee may be charged by the administrator of the search website as a fee for the convenience and flexibility of choosing an installment payment option. Even with the addition of the layaway fee, which can be relatively low, the installment payment option is often more convenient and cost-effective for the user.

The layaway fee may vary depending on the length of time between the ticket purchase date and the travel date. It may also vary depending on the total cost of the ticket being purchased. For example, a more expensive travel package may have a higher associated layaway fee. In certain embodiments, the layaway fee may be a fixed percentage of the cost of the travel package charged by the airlines, hotels, and/or ground transportation provider or providers. There may also be a required minimum layaway fee and/or a maximum layaway fee. The layaway fee may be based on a number of factors, such as, for example, the length of time between the travel package purchase and the travel date, as well the cost of the travel package before additional fees are added on.

In certain embodiments, a user may qualify for certain bonuses or rewards based on his purchase history and/or other account settings. For example, after making a predetermined number of purchases or spending a predetermined amount of money on travel packages, the user may qualify for a waived or reduced layaway fee on his next purchase. In another embodiment, a user may qualify for a free installment, reducing the total cost of his travel package by the cost of the free installment payment. The user may also qualify for bonuses or rewards by referring others to use the system and may receive his reward upon their travel package purchase using the system.

After processor 212 calculates the available travel package and payment options, they can be transmitted to device 210 via communications network 245. Device 210 may then display these options to the user using its input/output circuitry. Device 210 may also display any terms and conditions associated with the purchase of a package. The user can review the options and the terms and conditions and then select a payment option for his desired travel package.

A user can also make an initial payment using an electronic banking account, credit card account, or debit account. In certain embodiments, this initial payment may be equal to 30% of the cost of the travel package charged by the airline, hotel, and/or ground transportation provider or providers plus any fees calculated by processor 212. If the user chooses to make the initial payment using a credit card account, paying in installments available using system 200 often leads to lower overall credit card payments and balances than would otherwise result when using “standard” payment systems in which the user pays for the total cost of the flight on his credit card upfront. In certain embodiments, the user can set up a direct payment method whereby their credit card or debit card is automatically charged when an installment payment is due. A user may chose to turn this automatic payment feature off if he desires and may have the option of restarting the automatic payment feature after turning it off.

In certain embodiments, processor 212 can also be configured to send follow-up reminders and offers to a user, after the user selects which travel package and which payment option he wants. For example, processor 212 may send out payment reminders to a user shortly before the next installment payment is due. Processor 212 may also send out periodic updates regarding special offers available to the user. For example, processor 212 may send out refinancing offers, which can allow a user to reconfigure his installment payments. It may also send out emails asking the user to encourage his friends to use system 200 for their travel needs, such as by offering the user awards and discounts if and when his friends make purchases using the system.

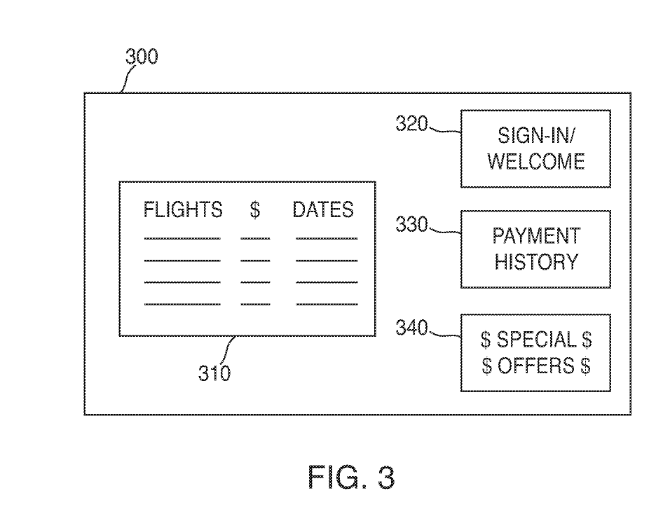

FIG. 3 is a schematic view of an illustrative user interface for controlling a website in accordance with one embodiment of the disclosed subject matter. User interface 300 may be displayed on input/output circuitry similar to input/output circuitry 118 of FIG. 2. User interface 300 can include, among other things, a user selection display 310, a user account settings/sign-in button 320, a payment history button 330, and a special offers button 340. In some embodiments, one or more components of user interface 300 may be combined or omitted. For example, if the user does not qualify for any special offers, special offers button 340 may be omitted. In certain embodiments, user account settings/sign-in button 320 and payment history button 330 may be combined into a single button or link.

Several different interface options may be available in accordance with the disclosed subject matter. For example, in certain embodiments, a display can show different images based on what stage of the travel purchase the user is in (e.g., searching for flights, reviewing payment options, customizing installment payments, etc.). In certain embodiments, user selection display 310 can display one or more text search boxes when the user performs his initial search. These boxes may also include pulldown menus listing a number of predetermined options (e.g., dates, flight destinations and airports). After the user enters his search preferences and a processor calculates available flights or packages and payment options, user selection display 310 can display the travel and payment options to the user. If a user logs into his account during the search process, user account settings/sign-in button 320 may display a link to a webpage where the user can review or adjust his search preferences and account settings. Before the user logs into his account, account settings/sign-in button 320 can display a button or form where the user can enter relevant account information such as a username and password to access his account. In certain embodiments, payment history button 330 can provide a link to a user's payment history, which may include, for example, billing information and/or information about previous purchases. If the user is not signed into his account or does not have any previous purchases using the installment payment system, button 330 may not appear on the display. Special offers button 340 can provide a link to special offers, such as travel sales, upcoming promotions, and discounts on installment payments that may be available to a user. As with payment history button 330, if the user is not signed into his account or does not have any previous purchases using the installment payment system, button 340 may not appear on the display.

In certain embodiments, a user may customize certain interface options. For example, the user may rearrange elements on the screen, change background display colors, and/or remove certain buttons from the display. The user's display preferences can be stored as part of his account information.

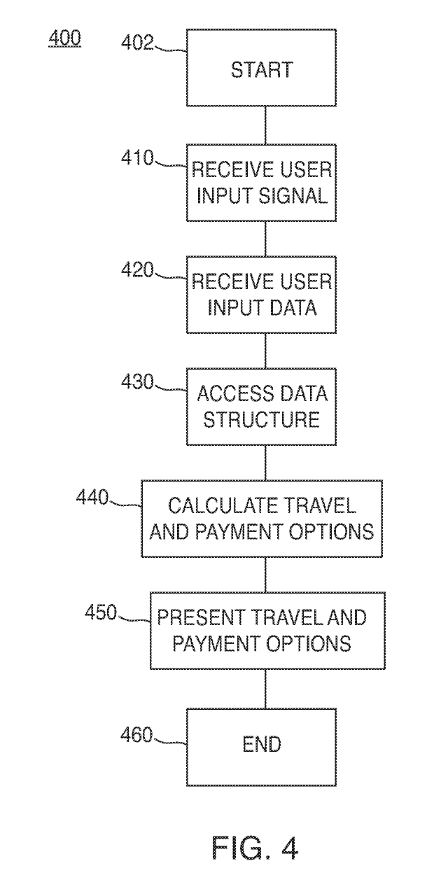

FIG. 4 is a flowchart of an illustrative process 400 for calculating payment options for an installment payment plan.

Process 400 starts at block 402. At block 410, a user input criteria can be received. This may be performed by input/output circuitry similar to input/output interface 118 of FIG. 1. The received input criteria can include various information, such as, for example, user login information, travel departure dates, travel return dates, price restrictions, and/or seating preferences, rental car preferences, hotel accommodation preferences, and the like.

At block 420, user input data is received. The user input criteria may be the same as the user input signal originally received by the input/output circuitry, or it may be data extracted from the user input criteria. For example, the extracted data can include metadata associated with the user login, search parameters, or other user preferences. Based on this data, a search for travel packages meeting the user's search criteria can be performed. In certain embodiments, this step can be performed by a processor similar to processor 212 of FIG. 2.

At block 430, one or more data structures can be accessed to determine available purchase and payment options. The data structure or data structures can be stored in a server's local memory or remotely on a remote server's memory. The device memory may be similar to memory 220 of FIG. 2, and the data structure or data structures may be similar to data structure 240 of FIG. 2. The server or servers storing the data structure may be similar to server 290 of FIG. 2. In some embodiments, based on user input data received in step 420, a processor can access data stored in at least one entry in at least one data structure. The processor may be similar to processor 212 of FIG. 2. For example, in certain embodiments, if the user input data indicates an preferred departure date or destination city for a trip, the processor can use this data to access data structure entries corresponding to these requirements.

At block 440, travel options and payment options can be determined. In certain embodiments, a processor can calculate which data structures have travel options that meet the user's search criteria, and based on these options, can calculate various payment options available to the user for that data structure entry. For example, after accessing relevant data in a database, a processor can calculate whether a user is eligible for an installment payment plan for that relevant data. The processor may be similar to similar to processor 212 of FIG. 2. In certain embodiments, purchasing a refundable flight ticket may automatically qualify the customer for an installment payment plan, subject to certain conditions. If the user is purchasing a non-refundable ticket or is not otherwise automatically qualified for an installment payment plan, he may still be able to pay using an installment plan if he purchases a “layaway option” that can be offered to him on the search website.

When the user qualifies for an installment payment plan, the processor can also calculate the number of installments and how much each installment will cost. The number of installments and the amount of each installment for a given installment payment plan can be calculated based on several different factors. For example, the number of installments may be based in part on how far in advance of a travel data the user books his flight. Additionally, the installment payments and duration between payments can be evenly divided or may be variable, depending on user-preferences and other considerations (e.g., user credit, total travel package cost, time remaining before the start date of the travel package, etc.). In certain embodiments, installments may be configured to vary throughout the installment payment cycle. They may increase or decrease throughout the course of the cycle based on user preferences.

A processor similar to processor 212 of FIG. 2 can also calculate the total cost of the user's purchase. The total cost can include the cost of the travel package to be charged by the airline, hotel, and/or ground transportation provider or providers and can also include a number of associated fees. For example, the fees may include any refund or cancellation fees that may be charged by the airline or package provider, administration fees charged by search consolidators that may provide the initial list of available travel packages, and any layaway fees that may be required as a condition of selecting a certain installment payment plan.

At block 450, the calculated travel options and payment options can be presented to the user. This step may be done on an input/output device similar to input/output interface 118 of FIG. 1. In certain embodiments, the processor can calculate which data structures have travel options that meet the user's search criteria in block 440 and present these options to the user before calculating payment options. The user can then further customize his travel package, selecting which travel options he is interested in, and the processor can then calculate appropriate payment options based on the user's updated selections as described in block 440. After the payment options are calculated, they can then be presented to the user. In other embodiments, a processor can calculate all possible travel and payment options before presenting them to the user. Process 400 can then end at block 460.

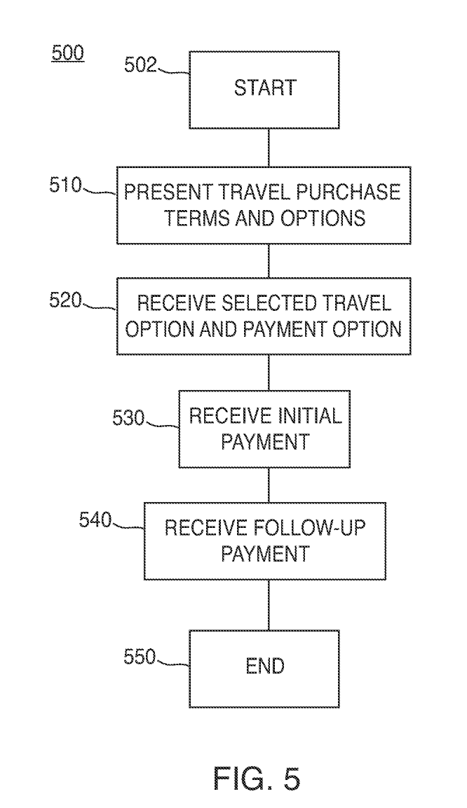

FIG. 5 is a flowchart of an illustrative process 500 for collecting installment payments.

Process 500 can start at block 502. At block 510, travel purchase options and terms can be presented to a user. Circuitry similar to input/output circuitry 250 of FIG. 2 can be used to perform this step. In addition to presenting travel and payment options, the circuitry can also be used to display any terms and conditions associated with the purchase of a travel package.

At block 520, the selected travel option and payment option can be received. This step may be performed by a processor similar to processor 212 of FIG. 2. After a user reviews the options available to him in step 510 and decides which option best meets his needs, he can input his selection using an input/output device similar to input/output device 250 of FIG. 2, which can then send the decision data to the processor for further processing.

At block 530, an initial payment can be received from a user via a processor. This step may also be performed by a processor similar to processor 212 of FIG. 2. The user can make a payment using a number of payment methods (e.g., an electronic banking account, credit account, or a debit account). In certain embodiments, this initial payment may be equal to 30% or any other percentage or fixed price point of the cost of the travel package charged by an airline, hotel, and/or ground transportation provider or providers plus any required fees. The required initial payment amount may vary, however, based on a number of factors such as, for example, a user's purchase history, credit history, loyalty rewards or coupons, the amount of time before the start date of the travel package, and/or any other discounts or applicable promotions.

At block 540, one or more follow-up installment payments can be received. This step may also be performed by a processor similar to processor 212 of FIG. 2. As with the initial payment received in block 530, a user can make follow-up installment payments using a number of payment methods (e.g., an electronic banking account, credit account, or a debit account). In certain embodiments, communications circuitry similar to communications circuitry 230 may communicate directly with a third party server (e.g., electronic banking server, credit account server, or a debit account server) to receive direct deposits from a user's account or accounts. In certain embodiments, the follow-up installment payments may be variable (e.g., installment payments may increase or decrease over time). The follow-up installment payments may also be fixed (e.g., each payment may be for the same amount). In certain embodiments, a user may be required to complete payment for the travel package by a certain amount of time before the travel date. For example, a system may require a user to complete payment at least two weeks prior to travel. If the user does not complete payment in time, a processor may cancel the user's booking. The processor may also send a notification to the customer, informing him that his booking is about to be cancelled and may offer him the option of purchasing a payment extension plan. If the user purchases such a payment extension plan, he may receive extra time (e.g., seven extra days) to pay the remaining money due for his travel purchase. In certain embodiments, the user may pay for one payment extension allowing him a fixed number of extra installments (e.g., three extra payment installments). Process 500 can then end at block 550.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above described embodiments of the disclosed systems and methods are presented for purposes of illustration and not of limitation. Further, it should be noted that the language used in the specification has been principally selected for readability and instructional purposes, and may not have been selected to delineate or circumscribe the disclosed subject matter. Accordingly, the disclosure of the presently disclosed subject matter is intended to be illustrative, but not limiting, of the scope of the claimed subject matter, which is set forth in the following claims.

What is claimed is:

1. An installment payment system comprising:
a data structure;
an input device;
an output device; and
a processor in operative communication with the input device, the output device, and the data structure, the processor operative to:
receive search parameters and consumer identification information from the input device;
access at least one transaction option stored in the data structure based on the search parameters;
determine that an installment payment option is available for a first transaction option of the at least one transaction option based on the search parameters and the consumer identification information;
calculate at least one payment plan for the installment payment option based on the first transaction option and the consumer identification information; and
transmit option data comprising the at least one transaction option and the at least one payment plan to the output device.

2. The system of claim 1, wherein the input device and the output device are part of a user-operated device.

3. The system of claim 1, wherein the processor is operative to calculate the at least one payment plan based on a purchase fee of the first transaction option.

4. The system of claim 3, wherein the purchase fee comprises installment option fees.

5. The system claim 1, wherein the processor is further operative to receive transaction selection data and installment payment selection data from the input device based on the transmitted option data.

6. The system of claim 5 wherein the processor is further operative to process transaction cancellation data associated with the installment payment selection data.

7. The system of claim 1, wherein the at least one transaction option comprises a refundable travel option.

8. An installment payment server comprising:
a communications circuitry; and
a processor in operative communication with the communications circuitry, the processor operative to:
receive search parameters and consumer identification information from the communications circuitry;
access at least one transaction option stored in a data structure based on the search parameters;
determine that an installment payment option is available for a first transaction option of the at least one transaction option based on the search parameters and the consumer identification information;
calculate at least one payment plan for the installment payment option based on the first transaction option and the consumer identification information; and
transmit option data comprising the at least one transaction option and the at least one payment plan using the communications circuitry.

9. The server of claim 8 wherein the data structure is stored on a remote device.

10. The server of claim 8 wherein the at least one transaction option comprises a flight option.

11. A method of calculating payment options comprising:
receiving search parameters and consumer identification information from an input device;
accessing at least one transaction option that satisfies the search parameters from a data structure;
determining that an installment payment option is available for a first transaction option of the at least one transaction option based on the search parameters and the consumer identification information;
calculating at least one payment plan for the installment payment option based on the first transaction option and the consumer identification information; and
transmitting option data comprising the at least one transaction option and the at least one payment plan to an output device.

12. The method of claim 11, further comprising transmitting payment reminders based on the at least one payment plan.

13. The method of claim 11, wherein the at least one payment plan comprises a variable installment payment plan.

14. The method of claim 11, wherein the at least one payment plan comprises a fixed installment payment plan.

15. The method of claim 11, wherein the at least one payment plan is based on a cancellation fee associated with the first transaction option.

16. The method of claim 15, wherein the cancellation fee is refundable.

17. The method of claim 11, wherein the at least one payment plan requires full payment before an initial travel date associated with the at least one transaction option.

18. The method of claim 11, wherein the at least one payment plan is based on an initial travel date associated with the first transaction option.

19. The method of claim 11, further comprising automatically cancelling a transaction associated with the at least one transaction option.

20. The method of claim 11, further comprising offering a payment extension before cancelling a transaction associated with the at least one transaction option.
